(19) United States
(12) Patent Application Publication
(10) Pub. No.: US 2005/0072370 A1
(43) Pub. Date: Apr. 7, 2005

(54) Birdhouse

(76) Inventor: Daniel D. Braden, Lakeview, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 10/679,837

(22) Filed: Oct. 6, 2003

(51) Int. Cl. A01K 31/00

(52) U.S. Cl. 119/431

(57) ABSTRACT

A birdhouse that has separate multi-unit, compartmentalized nesting chamber towers that can easily be removably mounted together. Having multiple units removably attached allows for easy cleaning and removal from the pole, and decreases the spread of disease. Also, having multiple ventilation areas within the nesting chambers of the birdhouse allows for greater air movement within the towers. The ventilation will help decrease the suffocation of young birds during the hot and humid months.

### CROSS-REFERENCES TO RELATED APPLICATIONS

### Not Applicable

### STATEMENT REGARDING FEDERALLY-SPONSORED RESEARCH AND DEVELOPMENT

### Not Applicable

### REFERENCE TO AN APPENDIX

### Not Applicable

### BACKGROUND OF THE INVENTION

1. Field of the Invention

This invention relates generally to a birdhouse, and more specifically to a multi-compartment birdhouse.

2. Description of the Related Art

It is well established that the purple martin prefers to nest in a birdhouse. In the Northeastern United States, the purple martin is very dependent on man-made birdhouses for nesting and reproduction. The purple martin is a very sociable bird making human interaction and care attractive. An effective destroyer of flying insects, one purple martin can consume up to 2,000 insects a day.

To facilitate a healthy colony of purple martins, it is necessary for the “landlord” to have access to the birdhouse. The birdhouse should be checked periodically and used nests should be removed. It is also important to check the nests for mites or lice that could stunt reproduction of the purple martin. It has been found that lowering the birdhouse and maintaining it will not disturb the purple martin or its young. Additionally, intruder species such as European starlings and English house sparrows invade the purple martin nests and out-compete the purple martin for nesting compartments. A landlord must diligently deter these species from invading the purple martin house.

Prior art birdhouses adapted for the purple martin are compartmentalized and have been placed upon a pole. However, most prior art houses are within a single housing. In this case, if one nest becomes infected with lice or a disease the entire colony can become infected. Cleaning may also be problematic with a single housing. It may be too time consuming, for the novice landlord, to clean each nesting compartment of the entire house at once. Furthermore, removing prior art birdhouses from a pole is very difficult, because the birdhouses can only be removed at the ends of the pole.

Therefore, there is a need for a purple martin birdhouse that has separate compartments that allow for easy cleaning and that decrease the spread of disease. The present invention fulfills these needs and provides other related advantages.

### BRIEF SUMMARY OF THE INVENTION

The invention is a birdhouse having a first pair of towers and a second pair of towers, each tower having four sidewalls attached to a floor and a ceiling, wherein two of the sidewalls are the back sidewalls of the towers and another two of the sidewalls are the front sidewalls of the towers. The back sidewall of a first tower is mounted to the sidewall of a second tower and the back sidewall of a third tower is mounted to the sidewall of a fourth tower. The birdhouse further includes a top mount unit and a base mount unit for removably mounting the first pair of towers to the second pair of towers, forming a central passageway.

The birdhouse pairs make removal from a pole easier since the two pairs can be separated, thereby making removal simple. The birdhouse halves are simply withdrawn from opposite sides of the pole. The bottom mount unit remains on the pole so that when the halves are reassembled, the bottom mount unit is re-attached to keep the tower pairs rigidly mounted together around the pole.

### BRIEF DESCRIPTION OF THE SEVERAL VIEWS OF THE DRAWINGS

FIG. 1 is a view in perspective illustrating an embodiment of the present invention.

FIG. 2 is a view in perspective illustrating a preferred embodiment of the present invention.

FIG. 3 is a bottom view illustrating a base mount unit of the present invention.

FIG. 4 is a top view illustrating a top mount unit of the present invention.

FIG. 5 is a view in perspective of an alternative embodiment of the present invention.

FIG. 6 is a view in perspective of an alternative embodiment of the present invention.

FIG. 7 is a front view illustrating a front sidewall of the present invention.

FIG. 8 is a cross-sectional side view illustrating one tower of the present invention.

FIG. 9 is a top view illustrating an alternative embodiment of the present invention.

FIG. 10 is a side view illustrating an alternative embodiment of the present invention.

FIG. 11 is a view in perspective illustrating a pole used in the present invention.

FIG. 12 is a view in cross-section of an embodiment of the present invention.

FIG. 13 is a bottom view illustrating an alternative base mount unit of the present invention.

FIG. 14 is a view in perspective illustrating an alternative embodiment of the present invention.

In describing the preferred embodiment of the invention, which is illustrated in the drawings, specific terminology will be resorted to for the sake of clarity. However, it is not intended that the invention be limited to the specific terms so selected, and it is to be understood that each specific term includes all technical equivalents, which operate in a similar manner to accomplish a similar purpose. For example, the word connected or terms similar thereto are often used. They are not limited to direct connection, but include connection through other elements where such connection is recognized as being equivalent by those skilled in the art.

### DETAILED DESCRIPTION OF THE INVENTION

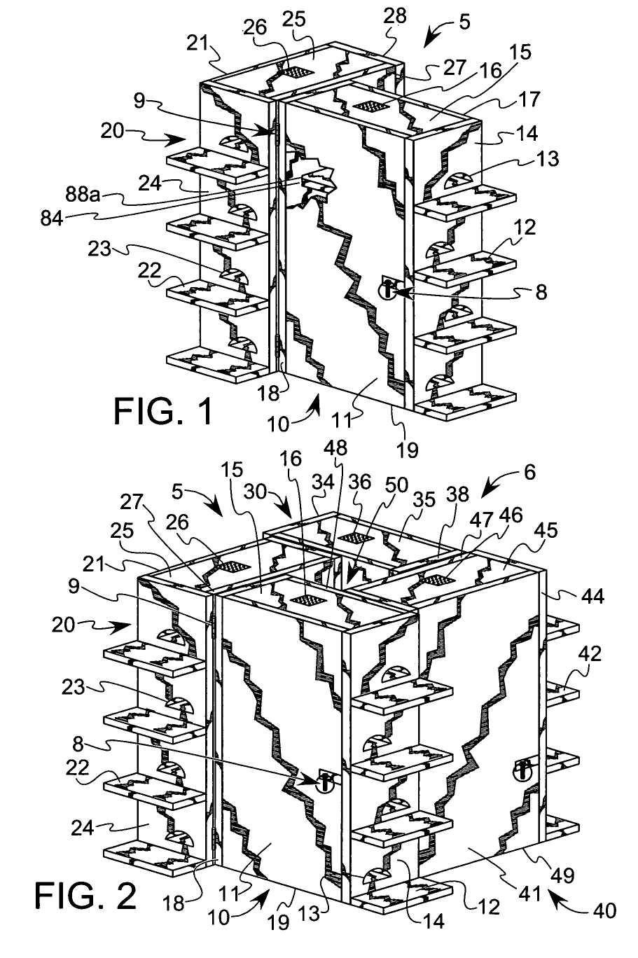

The preferred embodiment of the present invention is shown in FIGS. 1 and 2. The preferred embodiment is a birdhouse having a first tower 10 that has four sidewalls 11, 14, 17 and 18 attached to a floor 19 and a ceiling 15 and a second tower 20 having four sidewalls 21, 24, 27 and 28 attached to a floor 29 (see FIG. 13) and a ceiling 25. The towers are preferably made of wood, such as cedar, redwood or other weather-resistant materials, such as metal, plastic or a composite, such as fiberglass.

In the first tower 10 and the second tower 20, the sidewalls 14 and 24 form the fronts of the respective towers and the sidewalls 18 and 28 form the backs of the respective towers. This is significant because the back 18 of the first tower 10 is connected to the sidewall 27 of the second tower 20 to form a tower pair 5. The towers 10 and 20 of the tower pair 5 are connected together, such as by glue, screws, nails or any other manner that is suitable, and when viewed from the top the tower pair 5 has an L-shape. In the preferred embodiment, the back sidewall 18 of the first tower 10 is mounted to the sidewall 27 of the second tower 20 near the front sidewall 24. Alternatively, the back sidewall 18 of the first tower 10 can be mounted to the sidewall 27 of the second tower 20 near the back sidewall 28.

The preferred embodiment further includes a second tower pair 6 that includes a third tower 30 that has four sidewalls 31, 34, 37 and 38 attached to a floor 39 and a ceiling 35 and a fourth tower 40 that has four sidewalls 41, 44, 47 and 48 attached to a floor 49 and a ceiling 45, as shown in FIG. 2. In the towers 30 and 40, the sidewalls 23 and 44 form the fronts of the respective towers and the sidewalls 38 and 48 form the backs of the respective towers. The towers 30 and 40 of the tower pair 6 are connected together, such as by glue, screws, nails or any other manner that is suitable, and when viewed from the top the tower pair 6 has an L-shape. In the preferred embodiment, the back sidewall 38 of the third tower 30 is mounted to the sidewall 47 of the fourth tower 40 near the front sidewall 44. Alternatively, the back sidewall 38 of the third tower 30 can be mounted to the sidewall 47 of the fourth tower 40 near the back sidewall 48. Thus, ultimately all four towers are connected together to form the birdhouse.

The L-shaped configuration of the tower pairs 5 and 6 makes it possible to removably attach the second pair 6 of towers to the first pair 5 of towers, and thereby form a central passageway 50 for inserting a pole 130, shown in FIG. 2. More accurately, the tower pairs 5 and 6 are assembled around the pole by mounting the pairs together with the pole in the central passageway 50.

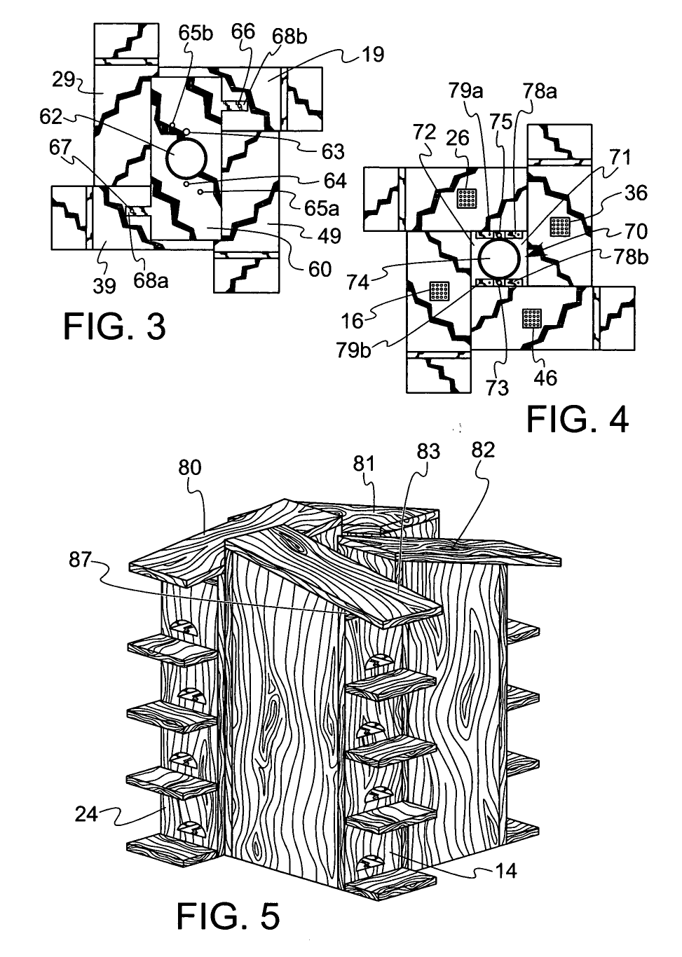

The tower pairs 5 and 6 are preferably removably mounted to each other by at least one top mount unit 70 and at least one removably mounted base mount unit 60, shown in FIGS. 3 and 4. FIG. 2 shows the first tower pair 5 and the second tower pair 6 connected as preferred. Of course, the tower pairs 5 and 6 could be mounted together by other mounting means, such as screws, clamps, plates, or latches, to name a few of the fasteners that the person of ordinary skill will recognize as being possible substitutions for the mounting units 60 and 70. The top and base mount units 60 and 70 are preferred, however, because they can be made in various shapes to accommodate various pole shapes. Thus, one birdhouse can be securely mounted to a variety of pole types and shapes simply by varying the top and base mount units.

In the preferred embodiment, the base mount unit 60, shown in FIG. 3, is a planar metal plate having two base mount brackets 68a and 68b extending co-planar to the main body. The base mount unit 60 can alternatively be made of wood, composite or a variety of suitable, commonly used materials and can be divided into two or more separate pieces if desired.

There is a central opening 62 in the base mount unit 60 to accommodate the pole 130. Prior to pole 130 installation, the base mount unit 60 is placed along and around the pole 130. The base mount unit 60 remains on the pole 130 after removal of the tower pairs 5 and 6. The central opening 62 is shaped to accommodate the shape of the pole 130, whether circular, rectangular or any other shape.

As shown in FIG. 3, the base mount unit 60 is attached to the tower pair 5 by inserting the threaded end of a carriage bolt through the opening 66 in the bracket 68b and into a bore formed in the floor 19. The base mount unit 60 is attached to the other tower pair 6 by inserting the threaded end of another carriage bolt through an opening 67 in the bracket 68a and into a bore formed in the floor 39. The brackets 68a and 68b are diagonally opposed on the base mount unit 60, which offers a strong connection and by mounting the base mount unit 60 to both towers 5 and 6, the towers 5 and 6 are rigidly mounted together.

An alternative-mounting configuration is illustrated in FIG. 13. Here, the base mount unit 90 is a plate having four openings 97, 98, 99 and 100 for mounting the base mount unit 90 to the tower floors 19, 29, 39 and 49. The threaded ends of four carriage bolts are inserted into each of the openings 97, 98, 99 and 100 and into a bore formed in the floors 19, 29, 39 and 49, respectively. This alternative-mounting configuration rigidly attaches the tower pairs 5 and 6. This is only one example of alternative mounting configurations. Of course, the person of ordinary skill will recognize other, equivalent mounting configurations.

The base mount unit 60 has a cable guide or slot 63 through which the pulley cable 134 extends and a second opening 64 through which the terminating the end 136 of the cable 134 extends. The terminating end 136 of the cable, shown in FIG. 12, seats against the underside of the base mount unit 60. The terminating end 136 of the cable is terminated in a conventional manner using a wire rope thimble (not shown) and two wire rope clamps 138a and 138b. From the terminating cable end 136, the cable 134 extends upwardly, through the opening 64 and through the opening 75 in the top mount unit and over the pulley at the top of the pole 130. The cable 134 proceeds down the opposite pole side through the slot 63 to a winch, which controls the height of the birdhouse. An equivalent suitable material used to hoist a heavy object, such as a rope, can replace the pulley cable 134.

The base mount unit 60 has an air vent opening 65a and preferably a second air vent opening 65b. The openings 65a and 65b aid in the movement of air through the towers 10, 20, 30 and 40 as described below by permitting air to enter the towers.

The top mount unit 70, shown in FIG. 4, is two half steel plates 71 and 72, each having two top mount brackets 78a, 78b, 79a and 79b, respectively, used to mount the top mount unit 70 to the inner sidewalls of each of the towers 10, 20, 30 and 40 which define the central passageway 50. Screws are inserted through the brackets 78a, 78b, 79a and 79b into the sidewalls of the towers for securing the top mount unit 70 to the sidewalls of the towers. However, a variety of other connecting means, such as glue, nails, rivets, etc., may be used to secure the top mount unit 70 to the inner sidewalls of the towers 10, 20, 30 and 40.

The top mount unit 70 has an opening 74 for inserting the pole 130, which is preferably the same shape and size as, and is aligned coaxially with, the opening 62 in the base mount unit 60. The top mount unit 70 may be made of any suitable material including wood or composite. The brackets 78a, 78b, 79a and 79b can be of any other suitable design. There is at least one opening 73 between two of the brackets 78b and 79b for the pulley cable 134 to extend through. The cable 134 extends from the winch 132, shown in FIG. 11, up through the hole 73 and over the pulley (not shown) mounted on the top of the pole 130 in a conventional manner. Preferably, there is a second opening 75 between the brackets 78a and 79a in which the cable 134 extends from the pulley to the terminating end 136 of the cable 134.

In the embodiment shown in FIG. 5, the roofs 80, 81, 82 and 83 are attached at an angle having a slight pitch to allow rain, snow, or other debris to slide off. The roofs 80, 81, 82 and 83 are mounted to the to the top of each tower 10 20, 30 and 40 leaving a gap 87 between the front sidewall 14 and the inner sidewall of the roof. This gap 87 allows air to move through the tower. The gap 87 in the embodiment extends along the front sidewall of the tower a sufficient distance. However, the gap 87 can be a variety of distances and shapes. In this embodiment, it is preferred that the ceilings 15, 25, 35 and 45 not be installed.

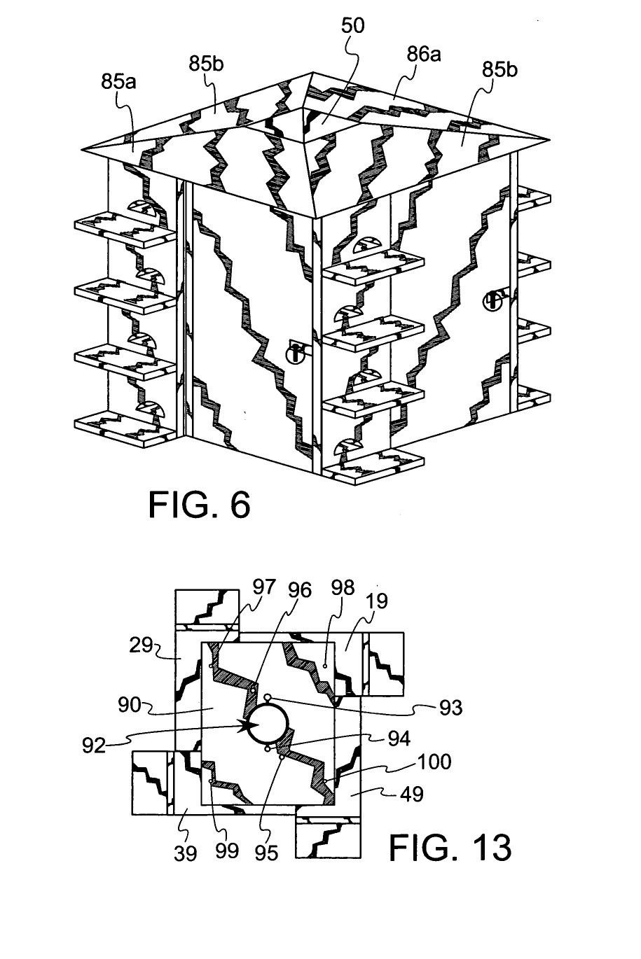

Alternatively, each of the towers 10, 20, 30 and 40 can have a ceiling 15, 25, 35 and 45, respectively, each of which is a single panel. The ceilings 15, 25, 35 and 45, shown in FIGS. 1 and 2, are used in conjunction with four roof coverings 85a, 85b, 86a and 86b, which form a roof with a central aperture aligned with the central passageway 50, shown in FIG. 6. The ceilings 15, 25, 35 and 45 each have a vent 16, 26, 36 and 46 for allowing air to escape from the tower. The roof coverings 85a, 85b, 86a and 86b are then attached over the ceilings 15, 25, 35 and 45 to create a uniform rooftop to shed precipitation. The roof coverings 85a, 85b, 86a and 86b are also slightly pitched to prevent snow and debris materials from collecting on top of the house.

The front sidewall 14 has a hinge 9 on one side, and preferably two aligned hinges for permitting opening and closing of the sidewall 14. A fastener 8 is located opposite the hinged side for locking the sidewall 14 in a closed position. The fastener 8 in the preferred embodiment is a lynch pin closure used for locking the sidewall 14 in place. However, the fastener 8 can be any suitable type of locking closure available.

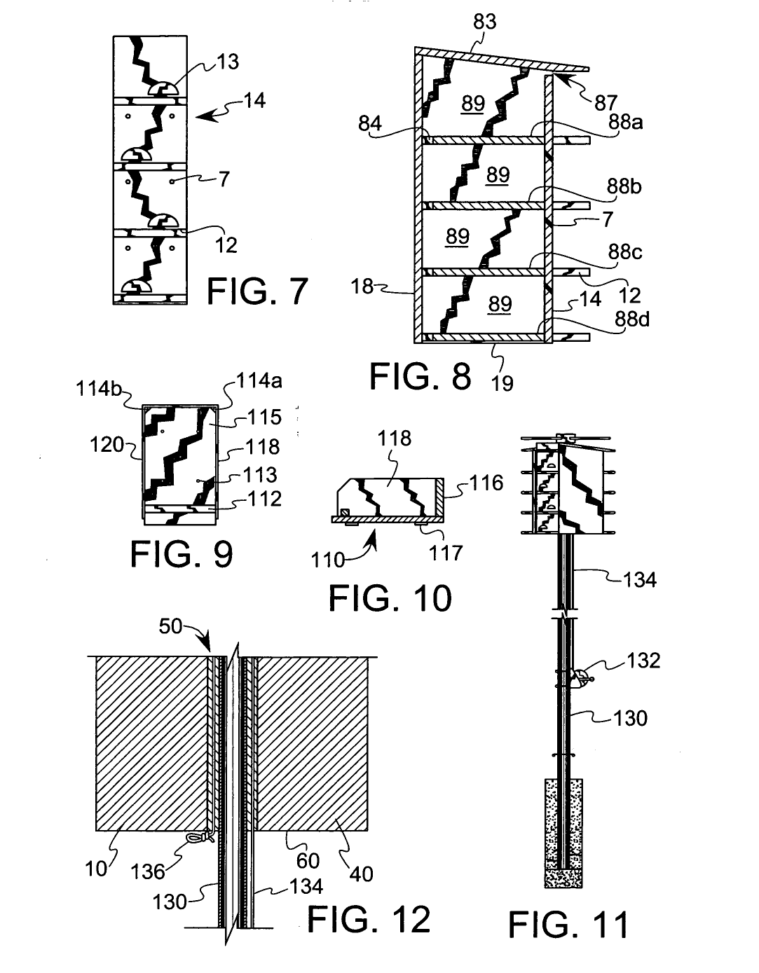

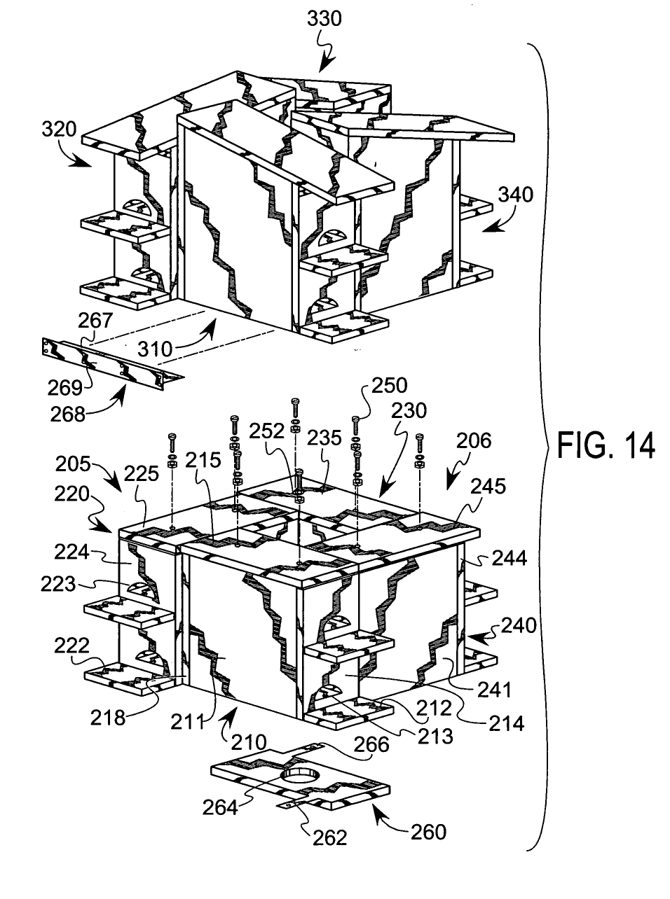

As shown in FIG. 7, the front sidewall 14 has one or more bird-sized openings 13 for the birds to enter each nesting chamber 89 (shown in FIG. 8). The openings 13 may be circular, crescent-shaped, or any other geometrical shape that birds will enter. Below each opening 13, a porch 12 can be attached perpendicular to the front sidewall 14. The birds use the porch 12 as an area to take off and land before entering the nesting chambers 89. The porch 12 is preferred, but is not necessary to the function of the birdhouse.

The front sidewall 14 has at least one air vent opening 7 for each nesting chamber 89. The air vent opening 7 is a small circular hole to allow for airflow throughout the tower. The vent opening 7 is angled to force the air to enter near the top of the nesting chamber 89 and to prevent rain from being driven into the opening. However, the vent opening 7 can be any suitable geometric shape or angle. The openings 13 can also serve as air vents, which would eliminate the need for additional openings.

FIG. 8 provides a cross-sectional side view of the first tower 10. The tower 10 is representative of the towers 10, 20, 30 and 40, and is described herein in detail. The towers 20, 30 and 40 are substantially identical to the tower 10. The tower 10 has nesting chambers 89 formed between the partitions 88a, 88b, 88c and 88d that are substantially parallel to the floor 19 and that extend between the sidewalls 14 and 18 (remaining sidewalls not shown). Preferably, there is a nesting chamber 89 between each of the partitions 88a-88d. In the preferred embodiment, the floor 19 serves as the partition 88d. There can be as many nesting chambers in each tower as are desired, from one or two to several.

As shown in FIG. 1, a cut-out portion of sidewall 11 shows that at least one gap 84 is formed between each of the partitions 88a-88d and the sidewall 18. The gap 84 on the partition 88a shown in FIG. 1 is found on all partitions in the preferred embodiment. Preferably, the gaps 84 are formed by chamfered corners on the partitions near the back sidewall 18 to allow air to flow through the tower. By leaving these gaps 84 in the partitions 88a-88d, air can enter from the bottom of each tower and from each air vent at the front of each tower, and exit through a gap at the top of the birdhouse as described below.

In the preferred embodiment, a gap is formed at both back corners of each of the partitions 88a-88d. However, the gap 84 can be positioned at any position between each of the partitions and the four sidewalls 11, 14, 17 and 18. For example, there can be four chamfered corners, or a gap at only one side of each of the partitions, or a half moon cut out of the back portion of the partitions. All of the nesting chambers 89 can have substantially the same type of gap 84 or a variety of different gaps can be incorporated into the chambers.

A nesting tray 110, as shown in FIGS. 9 and 10, may be inserted into the nesting chamber 89 for easier removal of the nest for cleaning. The nesting tray 110 comprises two sides 118 and 120, a floor 115 and a back 116. The floor 115 of the tray 110 preferably has two chamfered corners 114a and 114b that align with chamfered corners of the partitions 88a-88d for air movement. The front of the tray 110 is open to allow the birds to enter the tray. The tray 110 slidably engages, for example, the partition 88a inside the tower chamber and rests thereupon. The floor 115 of the tray 110 has at least two vent holes 113 for additional air movement. The nesting tray 110 can be easily removed from the nesting chamber for cleaning, replacement of old nests and to check on the young birds. Typically the purple martin does not mind if the nesting tray 110 is removed for cleaning as long as the tray is replaced and the tower is re-aligned when returned to the top of the pole.

FIG. 11 shows a pole 130 that the birdhouse is raised and lowered axially along by a conventional winch and pulley system. The cable 134 is connected to the base mount unit 60 as described above. A conventional hand winch 132 is connected to the pole 130 for the user to raise and lower the birdhouse. The pole 130 is typically made of steel, but can be made of wood, composite or any other suitable material. The pulley at the top of the pole 130 works with the winch 132 and cable 134 in a conventional manner to raise and lower the birdhouse.

The birdhouse is easily lowered from its operable orientation by releasing the tension of the cable 134. Once the house is lowered, the screws extending through the top mount brackets are removed. In addition, the carriage bolts are removed from the base mount brackets 68a and 68b, leaving the unattached base mount unit 60 and top mount unit 70 on the pole 130. The tower pairs 5 and 6 are separated and are removed from the pole. The birdhouse may be removed, for example, from the pole 130 for winter storage, cleaning, and maintenance. These steps are reversed for re-attaching the tower pairs 5 and 6 to the pole.

An “expansion unit” structure that can be added to the preferred birdhouse or any other similar birdhouse is shown in FIG. 12 attached to a two-chamber-per-tower birdhouse. The expansion unit allows a person with a one or two-chamber birdhouse to double, triple or otherwise multiply the number of chambers in his or her birdhouse by attaching a pair of tower pairs beneath the existing tower pairs. The expansion unit has a third tower pair 205 and fourth tower pair 206, each tower of each tower pair having four sidewalls attached to floors 219, 229, 239 and 249 and ceilings 215, 225, 235 and 245, respectively. The sidewalls 214, 224, 234 and 244 form the fronts of the respective towers and the sidewalls 218, 228, 238 and 248 form the backs of the respective towers.

The back sidewall 218 of the fifth tower 210 is connected to the sidewall 227 of the sixth tower 220 to form the tower pair 205. The towers of the tower pair 205 are connected, such as by glue, screws, nails or any other manner that is suitable, and when viewed from the top the tower pair 205 has an L-shape. The back sidewall 218 of the fifth tower 210 is mounted to the sidewall 227 of the sixth tower 220 near the front sidewall 224. Additionally, the back sidewall 238 of the seventh tower 230 is connected to the sidewall 247 of the eighth tower 240 to form the tower pair 206. The towers of the tower pair 206 are connected, such as by glue, screws, nails or any other manner that is suitable, and when viewed from the top the tower pair 6 has an L-shape. The back sidewall 238 of the seventh tower 230 is mounted to the sidewall 247 of the eighth tower 240 near the front sidewall 244.

The ceilings 215, 225, 235 and 245, respectively, are flat to allow for mounting with a fastener 250 to the floors of towers 310, 320, 330 and 340. A metal T-shaped strip 268 has one leg 267 that is placed between the ceiling 215 and the tower 310, while the arms 269 are mounted to the sidewalls of the towers 310 and 210 for support. The base mount unit 260, which is the load bearing point for the house, is removably mounted to the floors 219 and 239, as described above for the base mount unit 60. This alternative embodiment gives the landlord an expansion unit to add more nesting chambers to a birdhouse to increase his or her purple martin population. The chambers, air vents, doors and other structures of the expansion unit are designed to match the corresponding structures in the birdhouse.

While certain preferred embodiments of the present invention have been disclosed in detail, it is to be understood that various modifications may be adopted without departing from the spirit of the invention or scope of the following claims.

1. A birdhouse, comprising:
a) a first tower, having four sidewalls attached to a floor and a ceiling, at least one of said sidewalls being a back of the first tower and at least another of said sidewalls being a front of the first tower;
b) a second tower, having four sidewalls attached to a floor and a ceiling, at least one of said sidewalls being a back of the second tower and at least another of said sidewalls being a front of the second tower;
wherein the back of the first tower is mounted to the sidewall of the second tower to form a pair of connected towers.

2. A birdhouse according to claim 1, wherein the back of the first tower is mounted near the back of the second tower.

3. A birdhouse according to claim 1, wherein the back of the first tower is mounted near the front of the second tower.

4. A birdhouse according to claim 3, further comprising:
a) a third tower, having four sidewalls attached to a floor and a ceiling, at least one of said sidewalls being a back of the third tower and at least another of said sidewalls being a front of the third tower;
b) a fourth tower, having four sidewalls attached to a floor and a ceiling, at least one of said sidewalls being a back of the fourth tower and at least another of said sidewalls being a front of the fourth tower;
wherein the back of the third tower is mounted to the sidewall of the fourth tower forming a second pair of connected towers;
c) at least one top mount unit removably mounting a top of the first pair of towers to a top of a second pair of towers near a central passageway between the tower pairs; and
d) at least one base mount unit, having an opening defining a lower end of the central passageway, removably mounting a bottom of the first pair of towers to a bottom of the second pair of towers.

5. A birdhouse according to claim 3, further comprising:
a) a nesting chamber, having one or more partitions substantially parallel to the floor and extending between the sidewalls of the first, second, third and fourth towers; and
b) at least one gap between the partition and the sidewalls.

6. A birdhouse according to claim 5, wherein the said at least one gap further comprises at least two chamfered corners in the partitions to allow air movement within the tower.

7. A birdhouse according to claim 4, further comprising:
a) a nesting chamber, having one or more partitions substantially parallel to the floor and extending between the sidewalls of the first, second, third and fourth towers; and
b) at least one gap between the partition and the sidewalls.

8. A birdhouse according to claim 7, wherein the said at least one gap further comprises at least two chamfered corners in the partitions to allow air movement within the tower.

9. A birdhouse according to claim 4, wherein the base mount unit is connected to at least one bottom-mount bracket for connecting the first tower pair to the second tower pair.

10. A birdhouse according to claim 9, wherein the top mount unit is mounted to the sidewalls defining the central passageway for inserting a pole.

11. A birdhouse according to claim 10, wherein each ceiling is a single panel on each of the first, second, third and fourth towers.

12. A birdhouse according to claim 11, further comprising at least one pair of roof coverings, forming an aperture aligned with the central passageway.

13. A birdhouse according to claim 9, wherein the front sidewall is a door having at least one hinge on one side and a fastener on an opposite side for latching the door closed.

14. A birdhouse according to claim 13, wherein the front sidewall has one or more bird sized openings.

15. A birdhouse according to claim 14, further comprising at least one porch attached perpendicular to the front sidewall, positioned below the opening.

16. A birdhouse according to claim 15, wherein the front sidewall has at least one air vent opening for each nesting chamber.

17. A birdhouse according to claim 16, wherein a gap is formed between the roof and the front sidewall.

18. A birdhouse according to claim 7, further comprising:
a) a nesting tray having two sides, a floor and a back;
b) the floor of the tray having at least two chamfered corners for air movement;
c) the front of the tray being open to allow for birds entering the tray; and
d) the tray slidably engaging the partition inside the tower.

19. A birdhouse according to claim 9, wherein a cable is connected to the base mount unit to raise and lower the birdhouse.

20. A birdhouse according to claim 10, wherein the pole has a hand winch for the pulley cable.

21. A birdhouse, comprising:
a) a first pair of towers, each tower having four sidewalls attached to a floor and a ceiling, at least two of said sidewalls forming backs of the respective towers and at least another two of said sidewalls forming fronts of the respective towers,
wherein the back of a first tower is mounted to the sidewall of a second tower to form the first pair of towers;
b) a second pair of towers, each tower having four sidewalls attached to a floor and a ceiling, at least two of said sidewalls forming backs of the respective towers and at least another two of said sidewalls forming fronts of the respective towers,
wherein the back of a third tower is mounted to the sidewall of a fourth tower to form the second pair of towers;
c) at least one top mount unit removably mounting a top of the first pair of towers to a top of a second pair of towers and having an aperture defining a central passageway; and
d) at least one base mount unit, having an opening defining a lower end of the central passageway, said base mount unit removably mounted to a bottom of the first pair of towers and a bottom of the second pair of towers.

22. A birdhouse according to claim 21, wherein the back of the first tower is mounted near the front of the second tower.

23. A birdhouse according to claim 21, wherein the back of the third tower is mounted near the front of the fourth tower.

24. A birdhouse according to claim 21, further comprising:
a) a nesting chamber, having one or more partitions substantially parallel to the floor and extending between the sidewalls of the first, second, third and fourth towers; and
b) at least one gap between the partition and the sidewalls.

25. A birdhouse according to claim 24, wherein said at least one gap further comprises at least two chamfered corners in each of the partitions to allow air movement within the tower.

26. A birdhouse according to claim 21, wherein the base mount unit is connected to the first tower pair and the second tower pair.

27. A birdhouse according to claim 26, wherein a top mount unit is mounted to the sidewalls defining the central passageway.

28. A birdhouse according to claim 27, wherein each ceiling is a single panel on each of the first, second, third and fourth towers.

29. A birdhouse according to claim 28, further comprising at least one pair of roof coverings, forming an aperture aligned with the central passageway.

30. A birdhouse according to claim 29, wherein the front sidewall has at least one hinge on one side and a fastener on an opposite side.

31. A birdhouse according to claim 30, wherein the front sidewall has one or more bird sized openings.

32. A birdhouse according to claim 31, further comprising at least one porch attached perpendicular to the front sidewall, positioned below the opening.

33. A birdhouse according to claim 32, wherein the front sidewall has at least one air vent opening for each nesting chamber.

34. A birdhouse according to claim 33, wherein a gap is formed between the roof and the front sidewall.

35. A birdhouse according to claim 24, further comprising:
a) a nesting tray having two sides, a floor and a back;
b) the floor of the tray having at least two chamfered corners for air movement;
c) the front of the tray being open to allow for birds entering the tray; and
d) the tray slidably engaging the partition inside the tower.

36. A birdhouse according to claim 26, wherein a cable is connected to the base mount unit to raise and lower the birdhouse.

37. A birdhouse according to claim 27, wherein the pole has a hand winch for the pulley cable.

38. A birdhouse according to claim 21, further comprising an expansion unit having:
a) a third pair of towers, each tower in the third pair having four sidewalls attached to a floor and a ceiling, at least two of said sidewalls being a back of the towers and at least another two of said sidewalls being a front of the towers,
wherein the back of a fifth tower is mounted to the sidewall of a sixth tower;
b) a fourth pair of towers, each tower in the fourth pair having four sidewalls attached to a floor and a ceiling, at least two of said sidewalls being a back of the towers and at least another two of said sidewalls being a front of the towers,
wherein the back of a seventh tower is mounted to the sidewall of an eighth tower;
c) a fastener mounted to a floor of the first, second, third and fourth towers and through the flat ceiling of the fifth, sixth, seventh and eighth towers.

39. A birdhouse according to claim 38, wherein the back of the fifth tower is mounted near the front sidewall of the sixth tower.

40. A birdhouse according to claim 38, wherein the back of the seventh tower is mounted near the front sidewall of the eighth tower.

41. A birdhouse according to claim 38, wherein at least one base mount unit is removably mounted to a bottom of the fifth, sixth, seventh and eighth towers.

42. A birdhouse according to claim 41, further comprising:
a) a nesting chamber, having one or more partitions substantially parallel to the floor and extending between the sidewalls of the first, second, third and fourth towers; and
b) at least one gap between the partition and the sidewalls.

43. A birdhouse according to claim 42, wherein the said at least one gap further comprises at least two chamfered corners in the partitions to allow air movement within the tower.

44. A birdhouse according to claim 42, further comprising:
a) a nesting tray having two sides, a floor and a back;
b) the floor of the tray having at least two chamfered corners for air movement;
c) the front of the tray being open to allow for birds entering the tray; and
d) the tray slidably engaging the partition inside the tower.
